(19) United States
(12) Patent Application Publication
(10) Pub. No.: US 2007/0185880 A1
(43) Pub. Date: Aug. 9, 2007

(54) System and method to lease e-real estate

(76) Inventors: Harish Kumar, Anthem, AZ (US); Asheesh Kumar Gupta, Anthem, AZ (US); Shirish Wagh, Anthem, AZ (US)

Correspondence Address: WEISS & MOY PC, 4204 NORTH BROWN AVENUE, SCOTTSDALE, AZ, 85251, US

(21) Appl. No.: 11/336,669

(22) Filed: Jan. 20, 2006

(51) Int. Cl. G06F 7/00; G06F 17/30

(52) U.S. Cl. 707/10

(57) ABSTRACT

A system to lease e-private space to providers has a local e-real estate manager. The local e-real estate manager resides in a personal e-device of a user. The local e-real estate manager allows the user to configure an e-real estate of a user into a plurality of e-real estate elements and controls advertising on each of the e-real estate elements. A remote e-real estate manager is coupled to the local e-real estate manager for managing a relationship between the user and an advertiser. The remote e-real estate manager connects with the local e-real estate manager to upload and download information. The remote e-real estate manager uploading information related to a profile of the user and downloading advertisements to the local e-real estate manager for display. The remote e-real estate manager will offer different advertisement offers to the user from the advertiser based on the profile of the user. The user will enter into a lease agreement with the advertiser to rent out at least one of the e-real estate elements for monetary benefit of the user.

### FIELD OF THE INVENTION

The present invention relates to leasing a user's e-private space to a provider through e-methods and, more specifically, to leasing a user's e-real estate elements in his/her e-private space through online, synchronous, asynchronous and/or syndicated methods for effective and user consented advertising under lease agreement between lessee and lessor.

### BACKGROUND OF THE INVENTION

Presently, many e-commerce providers are taking advantage of the ignorance of people about his/her privacy rights in e-private space. E-private space or e-real estate may be generally defined as the area displayed on a monitor of an electronic device like a computer, laptop, cell phone, personal digital assistant (PDA) and the like. When these devices are activated, the operating system or other software programs display different images on the monitors/displays. Many e-commerce providers send/display different advertisements on the monitor without the user's permission. Displaying advertisements in one's e-private space without prior authorization is trespassing in his/her e-real estate.

E-commerce providers send/display advertisements in different manners. For example, the Internet has become a popular mode of communication. Consumers are seeing a rising trend in unsolicited advertisements “popping up” on the screen without any considerations. Consumers have very little choice or in some cases no choice to stop advertisements while surfing the Internet, or working off the Internet. This problem of unsolicited advertisements is a violation of e-real estate in consumer's e-private space. It interferes, distracts and takes away precious resource consumers want to enjoy i.e. privacy. The person or the entity having legal jurisdiction and ownership of personal e-devices should be the one deciding who is allowed to advertise in their personal space.

Two different approaches have been taken to solve the above mentioned problem. One approach being taken by companies is for these companies to start using sign-up agreement with consumers. The sign-up agreement is a contract where the consumer agrees to receive certain solicited advertisements from the company. These solicited advertisements are based on the consumer's profiles, interests, demography etc. The consumer's profile and the like are indicated on the sign-up agreement which the consumer submits to the company. However, this approach is geared towards the provider without any consumer consideration. Further, it is also based on unstructured legal agreements.

An alternative approach to unsolicited advertisements in one's e-private space is to block the advertisements. Companies have developed software and hardware solutions to define trespassing boundaries on e-private space by blocking unsolicited advertisements. However, these software and hardware solutions have only had limited success. This approach can also get very expensive and requires on-going maintenance by downloading new updates and adding new hardware features.

Therefore, a need existed to provide a system and method to overcome the above problem.

### SUMMARY OF THE INVENTION

A system to lease e-private space has a local e-real estate manager. The local e-real estate manager resides in a personal e-device of a user. The local e-real estate manager allows the user to configure an e-real estate of a user into a plurality of e-real estate elements and controls advertising on each of the e-real estate elements. A remote e-real estate manager is coupled to the local e-real estate manager for managing a relationship between the user and an advertiser. The remote e-real estate manager synchs with the local e-real estate manager to upload and download information. The remote e-real estate manager will upload information related to a profile of the user and download advertisements to the local e-real estate manager for display. The remote e-real estate manager will offer different advertisement offers to the user from the advertiser based on the profile of the user. The user will enter into a lease agreement with the advertiser to rent out at least one of the e-real estate elements for monetary benefit of the user.

A method to lease e-private space comprising: providing a local e-real estate manager, the local e-real estate manager residing in a personal e-device of a user, the local e-real estate manager allows the user to configure an e-real estate of a user into a plurality of e-real estate elements and controls advertising on each of the e-real estate elements; providing a remote e-real estate manager coupled to the local e-real estate manager for managing a relationship between the user and an advertiser, the remote e-real estate manager transmitting advertisements to the local e-real estate manager for display; downloading information related to a profile of the user from the a local e-real estate manager by the remote e-real estate manager; sending different advertisement offers to the user from the advertiser by the remote e-real estate manager; agreeing to terms of a lease agreement between the user and the advertiser for displaying an advertisement on at least one of the plurality of e-real estate elements of the user; and downloading the advertisement to the local e-real estate manager for display.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a conceptual view of a depiction of leasing entities;

FIG. 2 is a perspective view of a structural definition of Lease in current invention scope; and

FIG. 3 is a perspective view of a managing lease terms in e-private space.

Common reference numerals are used throughout the drawings and detailed description to indicate like elements.

### DESCRIPTION OF THE PREFERRED EMBODIMENT

Referring now to the Figures, a system and method to lease e-real estate 13 existing in e-private space 12 is disclosed. E-private space 12 may be defined as virtual private space existing on personal e-device 11(s) such as cellular phones, mobile and desktop computers, personal digital assistants, and the like. It may also include a television that is coupled to a computer system. Each of these e-devices 11 generally has a display or monitor. When these e-devices 11 are activated, the operating system or other software programs will display different images on the monitors/displays. This is a person's e-private space 12. It should be known that the listing of the above are given as examples and should not be seen as to limit the scope of the present invention.

A user 15 of the personal e-device 11 can lease the e-real estate 13 to a lessee 16 for advertising 17. The user 15 may be the owner of the e-device 11. Alternatively, the user 15 may just be the person using the e-device 11 and the e-device 11 may be owned by a company (i.e., a person's work computer). In the later case, the owner of the e-device 11 (i.e., the company) would need to allow the user 15 to lease the e-real estate 13 to a lessee 16 for advertising 17. A lessee 16 is defined as a provider, which can be advertisement 19-provider and/or service-provider and/or advertiser and/or third party, who leases lessor's e-private space 12. The above is given as an example and should not be seen as to limit the scope of the present invention. Advertising 17 is defined as a process to promote advertisement 19(s) about products and services in e-private space 12 under lease terms.

In accordance with the present invention, a user 15 has the option to lease specific e-real estate 13 components called e-real estate element 14(s) and/or their parts in e-private space 12. An e-real estate element 14 is a property defined as virtual physical-media in which advertisement 19(s), contents about products and services such as text, graphical user interface, multimedia presentations, are displayed. E-real estate elements 14 can be any area on a display where advertisements may be displayed. The user 15 can configure these e-real estate element 14(s) through various parameters defined in the lease terms. An agent called an e-real estate Manager 18 is defined to control, manage lease terms and advertisement 19(s) in user's e-private space 12.

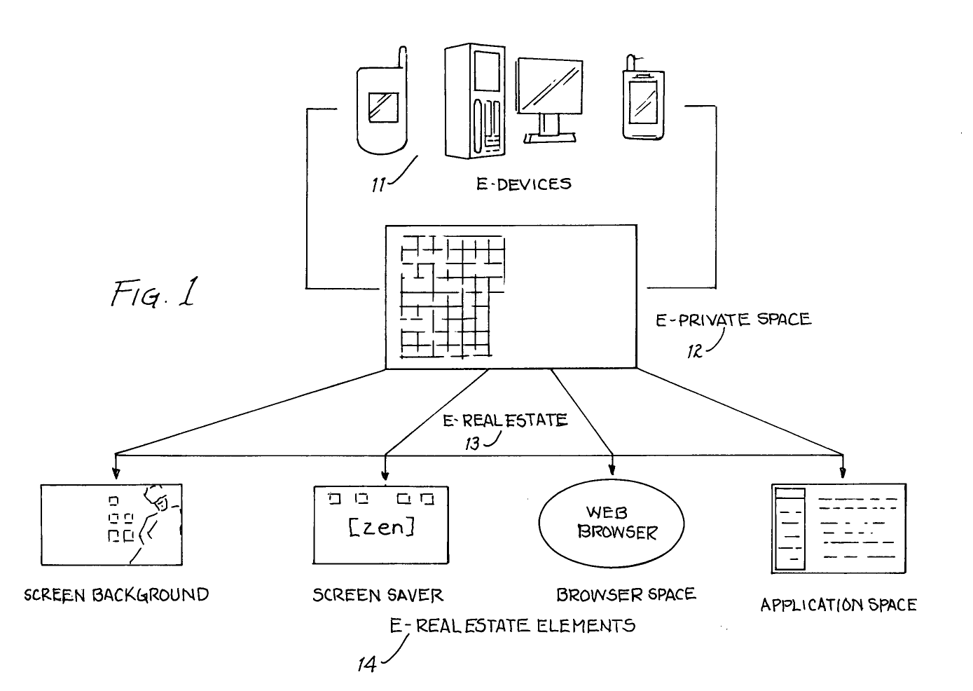

Referring specifically to FIG. 1, as may be seen more specifically, a user's e-private space 12 may include, but is not limited too, screen background including the taskbar and start menu, screen saver, browser space and application space. Again, the listing of the above is given as examples and should not be seen as to limit the scope of the present invention. Any area on a display in which advertisement 19(s) can be displayed may be considered to be a user's e-private space 12. Advertising 17 on e-real estate element 14 is not limited to any means of electronic communications or protocols nor any formats of advertisement 19(s). Promotion of advertisement 19(s) can be based on any existing online, synchronous, asynchronous and/or syndicated methods or any new future e-method.

The user 15 can configure an e-real estate element 14 in different manners in order to lease different e-real estate elements 14. For example:

1. A user 15 may divide the task bar or start menu into different e-real estate elements which may be leased in whole or in part.

2. A user 15 can configure the screen background in such a way that he/she may opt to lease the entire screen background.

3. A user 15 can configure the screen background in such a way that he/she may opt to lease different parts of the screen background defined as mxn matrix instead of the entire screen background.

4. A user 15 can configure the screen saver in such a way that he may opt to lease the screen saver.

5. A user 15 can configure the screen saver in such a way that he may opt to lease the screen saver for certain time period during the day instead of all the time.

6. A user 15 can configure the browser space in such a way that when he/she opens a browser window it opens a local web page sitting on his/her e-private space 12 that can be leased in whole or in different section. Similarly he/she can opt to open a remote personalized web site page whenever the browser window gets open and again that web site page was leased based on his/her preferences.

7. A user 15 can configure Application space in such a way that whenever he/she runs a specific application such as messenger then all advertisement 19(s) coming through messenger are displayed in either any leased panels of application or opens a new leased window. However this kind of option can be provided only when lessee 16 and third party application are in agreement to promote this lease business function.

It should be noted that the above are given as examples. The user 15 can configure the e-real estate element 14 in different manners without departing from the spirit and scope of the present invention.

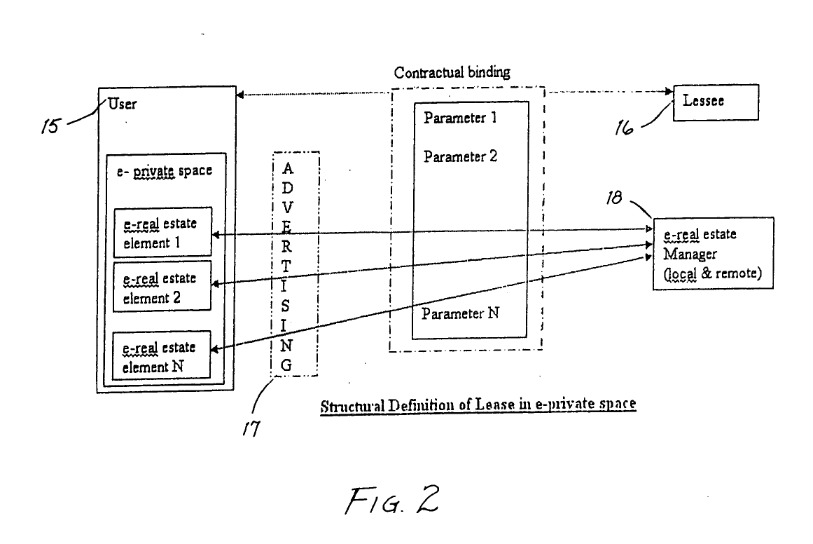

Referring now to FIG. 2, a structural definition of the lease in the current invention scope is disclosed. An agent called an e-real estate manager 18 is defined to control, manage lease terms and advertisement 19(s) in user's e-private space 12. The manager 18 will offer different advertisement offers to the user 15. The user 15 will enter into a lease agreement with a lessee 16 to rent out certain e-real estate element 14(s). The lease is a binding contractual agreement between the user 15 (lessor who is owner of an e-private space 12) and the lessee 16. The lease will contain different parameters under which the user 15 can lease e-real estate element 14(s) and parts to the lessee 16 for promoting advertisers' products and services. In return, the user 15 will be able to collect rent and other monetary benefits. Monetary benefits can be in terms of cash backs, discounts on merchandise, and/or any other credits. The listing of the above is given as examples and should not be seen as to limit the scope of the present invention. It should be noted that in the situation where the user 15 the person using the e-device 11 and the e-device 11 is owned by a company, the company may also be given certain monetary benefits for allowing the user 15 to rent out certain e-real estate element 14(s) on the different e-devices 11 owned by the company. Unlike the prior art, the user 15 will actually lease certain areas e-real estate element 14(s). It is more streamlined and structured as compared to sign-up agreement process as it exists today. Present sign-up agreements generally send out e-mail advertisements to the party that signs up. The present sign-up agreements do not actually lease out different e-real estate element 14(s).

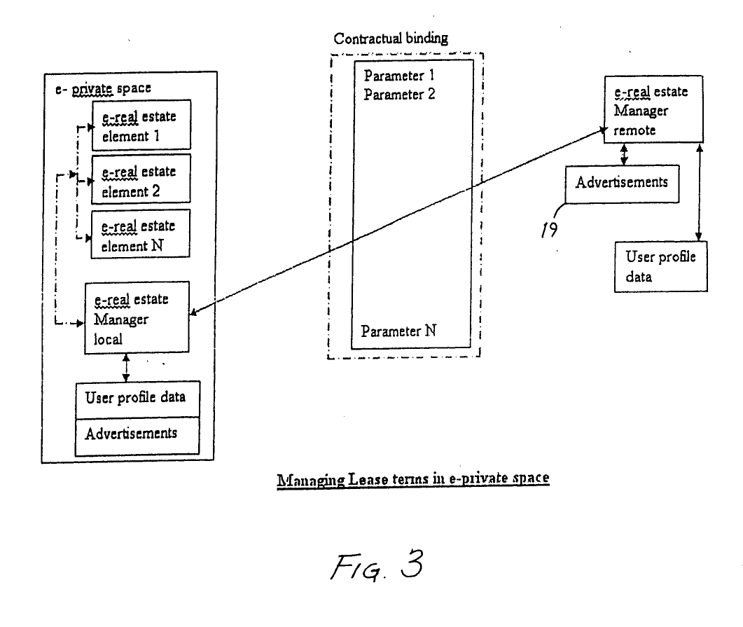

Referring now to FIG. 3, a more detail discussion of the relationship between the e-real estate manager 18 and the user 15 will be disclosed. The e-real estate manager 18 is the one, responsible for controlling, managing and providing a good user experience. The e-real estate manager 18 is an interface that is resident on one or various parts of the lease system. The e-real estate manager 18 can interface and facilitate the interaction between the user 15 and the lessee 16.

In accordance with one embodiment of the present invention, the e-real estate manager 18 may have two components, one local called a local e-real estate manager and one remote called a remote e-real estate manager 18. The local e-real estate manager 18 resides in user's e-private space 12 and is responsible for controlling and managing advertising on the e-real estate element 14(s). It is also responsible for giving user 15 the option to configure various parameters and sync with the remote e-real estate manager 18. The local e-real estate manager is a program that will reside in the personal e-device 11 of the user 15. The local e-real estate manager 18 will allow a user to configure his/her e-real estate element 14 in different manners as disclosed above. The local e-real estate will further manager managing which ads will be displayed on which e-real estate element 14(s) and for what period of time.

The remote e-real estate manager 18 resides at a provider site. The e-real estate manager 18 is responsible for controlling and managing the relationship between the user 15 and the lessee 16. When lease agreements are formed between the user 15 and the lessee 16, the remote e-real estate manager 18 will record the agreement and forward the advertisement to be displayed. The remote e-real estate manager 18 is also responsible for controlling and managing each local e-real estate manager 18(s). The remote e-real estate manager will sync with the local e-real estate manager to upload and download information. For example, the remote e-real estate manager may upload information related to the user profile. The remote e-real estate manager may further upload information such as where the user will display advertisements and for what period of time. The remote e-real estate manager will transfer the advertisements to the local e-real estate manager for display. The remote e-real estate manager may also monitor the whether or not the user 15 is displaying the advertisement 19 in accordance with the lease agreement. The advertisement 19 may be coded to send back a signal to the remote e-real estate manager so that the remote e-real estate manager may further monitor the whether or not the user 15 is displaying the advertisement 19 in accordance with the lease agreement. The remote e-real estate manager 18 is responsible for managing the profiles of each user 15. The remote e-real estate manager 18 will send advertisement offers that match the particular profile of the user 15.

The present invention establishes a business model which allows a user 15 to take charge of their e-privacy world and provides opportunities to accumulate and earned money and credits by allowing interaction with provider(s) in a controlled and managed environment at their own terms. The system and method to lease e-real estate 13 gives the user 15 full control of their e-private space 12 and encourages them to share it with provider(s). As it promotes the user 15(s) to share their e-private space 12, it further provides advertisers a better and legal way to reach customers in a particular market.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A system to lease e-private space comprising:
a local e-real estate manager residing in a personal e-device of a user, the local e-real estate manager allows the user to configure an e-real estate of a user into a plurality of e-real estate elements and controls advertising on each of the e-real estate elements; and
a remote e-real estate manager coupled to the local e-real estate manager for managing a relationship between the user and an advertiser, the remote e-real estate manager connecting with the local e-real estate manager to upload and download information, the remote e-real estate manager uploading information related to a profile of the user and downloading advertisements to the local e-real estate manager for display;
wherein the remote e-real estate manager will offer different advertisement offers to the user from the advertiser based on the profile of the user, the user entering into a lease agreement with the advertiser to rent out at least one of the e-real estate elements for monetary benefit of the user.

2. A system to lease e-private space in accordance with claim 1 wherein the e-real estate is a display area on the personal e-device of the user.

3. A system to lease e-private space in accordance with claim 1 wherein the personal e-device of the user is one of: a cellular phone, a mobile computer, a desktop computer, and a personal digital assistant.

4. A system to lease e-private space in accordance with claim 1 wherein an e-real estate element is a virtual physical-media in which advertisements such as text, graphical user interface, and multimedia presentations may be displayed.

5. A system to lease e-private space in accordance with claim 1 wherein an e-real estate comprises: screen background, taskbar, start menu, screen saver, browser space and application space.

6. A system to lease e-private space in accordance with claim 1 wherein monetary benefits comprises: cash, discounts on merchandise, and credits.

7. A system to lease e-private space in accordance with claim 1 wherein the advertisements comprises: static ads, dynamic ads, interactive ads, and combinations thereof.

8. A system to lease e-private space comprising:
a personal e-device of the user having a display area, the display area being the e-real estate of a user;
a local e-real estate manager residing in the personal e-device of a user, the local e-real estate manager allows the user to configure the e-real estate of the user into a plurality of e-real estate elements and controls advertising on each of the e-real estate elements; and
a remote e-real estate manager coupled to the local e-real estate manager for managing a relationship between the user and an advertiser, the remote e-real estate manager transmitting advertisements to the local e-real estate manager for display based on a lease agreement between the provider and the advertiser.

9. A system to lease e-private space in accordance with claim 8 wherein the remote e-real estate manager further downloads and uploads information to and from the local e-real estate manager, the remote e-real estate manager uploading information related to a profile of the user and downloading the advertisements to the local e-real estate manager for display, the remote e-real estate manager sending different advertisement offers to the user from the advertiser based on the profile of the user, the user entering into the lease agreement with the advertiser to rent out at least one of the e-real estate elements for monetary benefit of the user.

10. A system to lease e-private space in accordance with claim 8 wherein the personal e-device of the user is one of: a cellular phone, a mobile computer, a desktop computer, and a personal digital assistant.

11. A system to lease e-private space in accordance with claim 8 wherein an e-real estate comprises: screen background, taskbar, start menu, screen saver, browser space and application space.

12. A system to lease e-private space in accordance with claim 8 wherein the advertisements comprises: static ads, dynamic ads, interactive ads, and combinations thereof.

13. A method to lease e-private space comprising:
providing a local e-real estate manager, the local e-real estate manager residing in a personal e-device of a user, the local e-real estate manager allows the user to configure an e-real estate of a user into a plurality of e-real estate elements and controls advertising on each of the e-real estate elements;
providing a remote e-real estate manager coupled to the local e-real estate manager for managing a relationship between the user and an advertiser, the remote e-real estate manager transmitting advertisements to the local e-real estate manager for display;
downloading information related to a profile of the user from the a local e-real estate manager by the remote e-real estate manager
sending different advertisement offers to the user from the advertiser by the remote e-real estate manager;
agreeing to terms of a lease agreement between the user and the advertiser for displaying an advertisement on at least one of the plurality of e-real estate elements of the user; and
downloading the advertisement to the local e-real estate manager for display.

14. The method of claim 13 further comprising giving a monetary benefit to the user for displaying the advertisement on at least one of the plurality of e-real estate elements of the user.

15. The method of claim 13 further comprises configuring an e-real estate of a user into a plurality of e-real estate elements by the user.

16. The method of claim 13 wherein downloading the advertisement further comprises downloading one of a static advertisement, dynamic advertisement, interactive advertisement, and combinations thereof.

17. The method of claim 13 wherein sending different advertisement offers to the user from the advertiser by the remote e-real estate manager further comprises sending different advertisement offers to the user from the advertiser by the remote e-real estate manager based on the profile of the user.

18. A system to lease e-private space comprising:
a personal e-device of the user having a display area, the display area being the e-real estate of a user;
an e-real estate manager that configures the e-real estate of the user into a plurality of e-real estate elements and controls advertising on each of the e-real estate elements and for managing a relationship between the user and an advertiser, the e-real estate manager transmitting advertisements to the user for display based on a lease agreement between the provider and the advertiser.

19. A system to lease e-private space in accordance with claim 18 wherein the e-real estate manager comprises:
a local e-real estate manager residing in the personal e-device of a user, the local e-real estate manager allows the user to configure the e-real estate of the user into a plurality of e-real estate elements and controls advertising on each of the e-real estate elements; and
a remote e-real estate manager coupled to the local e-real estate manager for managing a relationship between the user and an advertiser, the remote e-real estate manager transmitting advertisements to the local e-real estate manager for display based on a lease agreement between the provider and the advertiser.

20. A system to lease e-private space in accordance with claim 18 wherein the remote e-real estate manager further downloads and uploads information to and from the local e-real estate manager, the remote e-real estate manager uploading information related to a profile of the user and downloading the advertisements to the local e-real estate manager for display, the remote e-real estate manager sending different advertisement offers to the user from the advertiser based on the profile of the user, the user entering into the lease agreement with the advertiser to rent out at least one of the e-real estate elements for monetary benefit of the user.
